(19) United States
(12) Patent Application Publication
(10) Pub. No.: US 2002/0038346 A1
(43) Pub. Date: Mar. 28, 2002

(54) Method for screen image sharing

(76) Inventors: Frank Morrison, Sylmar, CA (US); Mike Fullerton, Sunland, CA (US)

Correspondence Address: KLEINBERG & LERNER, LLP, Suite 1080, 2049 Century Park East, Los Angeles, CA, 90067, US

(21) Appl. No.: 09/927,983

(22) Filed: Aug. 10, 2001

Related U.S. Application Data
(60) Provisional application No. 60/224,460, filed on Aug. 10, 2000.

(51) Int. Cl. G06F 15/16

(52) U.S. Cl. 709/205; 709/217

(57) ABSTRACT

A host computer is described which enables a plurality of guest computers of different types to view the screen of a remote host computer directly over the Internet using screen sharing software and a standard web browser. Each computer receives an appropriate set of instructions from a web server to activate their local screen sharing application. This activation allows said computers to cease to communicate with the web server and establish a direct communication with the remote host computer.

This application claims the priority date of prior copending U.S. Provisional Application Ser. No. 60/224,460, the entire disclosure of which is incorporated herein by reference.

### BACKGROUND OF THE INVENTION

1. Field of the Invention

This invention relates generally to the field of computer teleconferencing (to hold a conference via a telephone or network connection), and more particularly to a method for screen image sharing among heterogeneous computers connected via a standard web browser (a software application used to locate and display Web pages) without the involvement of a web server (A computer that delivers -serves up- Web pages) for the actual screen sharing session.

2. Description of the Related Art

The present invention relates to sharing computer screen information among computers of different types with the use of a standard web browser. In particular, this invention relates to a method by which a computer receives the proper instructions from an internet web server to launch said computer's screen sharing program to observe and/or control what is displayed on a remote computer. In the context of the present invention, a computer refers to a personal computer such as the Macintosh, manufactured by Apple Computer, Inc., and a variety of many IBM-compatible computers such as those manufactured by the International Business Machines Corporation and by Sun Microsystems, Incorporated. In the context of the present invention, a screen-sharing program is a software application allowing two or more computers to control and/or observe the screen of a remote host computer.

The technology of computer screen sharing is widely known and used among computers of the same or compatible design (“homogeneous computers” as described in prior arts, U.S. Pat Nos. 4,823,108-4,538,992 and 4,622,545) and among computers with different platforms (“heterogeneous computers” as described in U.S. Pat No. 5,241,625) either on local networks or on the Internet. Screen sharing involves capturing the computer screen information of one computer (hereafter also referred to as “host”), which is used by another computer (hereafter also referred to as “guest”) to playback the captured image information. If the two computers are of the same or a compatible type, computer screen sharing is said to be homogeneous. If the computers are of different types, the screen sharing is heterogeneous.

Screen sharing programs make use of the TCP/IP protocol (Transmission Control Protocol/Internet Protocol, the suite of communications protocols used to connect computers on the Internet) in order for them to work over the World Wide Web. A computer whose purpose it is to control and/or observe a remote computer uses screen-sharing software that requires the IP address (an identifier for a computer on a TCP/IP network) of the remote computer.

This requirement of screen-sharing programs for the IP address of the remote computer is a big disadvantage. The majority of Internet users have a dial-up connection (they make use of a modem to connect their computers to the Internet). With millions of people signing up for dial-up access, Internet Service Provider companies such as America On-line and Earthlink make use of Dynamic Host Configuration Protocol, a protocol for assigning dynamic IP addresses to computers on a TCP/IP network. With dynamic addressing, a computer can have a different IP address every time it connects to the Internet. Dynamic addressing simplifies network administration because the software keeps track of IP addresses rather than requiring an administrator to manage the task. This means that a new computer can be added to a network without the difficulty of manually assigning it a unique IP address. Unfortunately, the users of screen sharing software could never connect to each other automatically because their computers receive different IP addresses every time they dial-up to the Internet. Therefore, a person trying to observe and/or control a remote computer with dial-up access has to somehow communicate with the person operating the remote computer by means other than their computer to get the IP address before they can properly use their screen-sharing program.

Placeware's Web Conference (a software program developed by Placeware Inc.) and CentraNow (a software program developed by Centra Software, Inc.) solved the IP address disadvantage with the introduction of a third application residing on an Internet web server. Internet web servers, by nature of their design, automatically capture the IP addresses of the computers connecting to them. The system works by having the observing computers and the host computer connected to a web server application at the same time. The web server application then automatically captures the IP addresses of the observing computers and acts as the middle link between guest computers and the remote or host computer. However, their technology only works on computers of the same kind (homogeneous computers) because creating a system that will work on a heterogeneous network (a network that includes computers and other devices of different types) requires further processing.

Farallon Computing Inc., the assignees of U.S. Pat No. 5,241,625 on “screen image sharing on heterogeneous computers” granted the use of their intellectual property for the creation of Timbuktu Web Seminar (TWS) (a software program developed by Netopia, Inc. and Pixion, Inc.), which is the only solution that works on a heterogeneous network. Their system also makes use of a web server in conjunction with a web server application. However, their current method has several disadvantages. One of them is that all computers have to remain connected at all times to the web server during the screen sharing process. Another disadvantage is that web server applications are developed specifically for use on the platform (The underlying hardware or software for a system) of the computer in mind. This presents us with increased costs in developing the equivalent web server application for other server platforms. A third disadvantage is that web server applications, by nature of their design, require that all computers they serve remain connected to the web server at all times, thus requiring more bandwidth (The amount of data that can be transmitted in a fixed amount of time) as more computers connect to them. A fourth disadvantage is that the remote host computer must also remain connected at all times to the web server.

### SUMMARY OF THE INVENTION

It is an object of the invention to provide an easy and cost effective cross-platform (the capability of software or hardware to run identically on computers of different underlying hardware or software) method for browser-based screen sharing among heterogeneous computers over the Internet.

A further object of the invention is to allow screen sharing without involving a web server during the actual screen sharing process.

A further object of the invention is to allow screen sharing over the Internet without the development of web server applications for each specific platform.

A further object of the invention is to provide a method for any computer to become a web server in a web-based screen sharing system regardless of its platform.

A further object of the invention is to provide a substantial reduction of bandwidth requirements to an Internet web server in a screen sharing Internet system.

A further object of the invention is to provide a dynamic management and administration tool to control the internet-based screen sharing system.

A further object of the invention is to provide an easier and automatic remote screen sharing method using a standard web browser over the Internet.

A further object of the invention is to provide an Internet browser-friendly method for screen sharing.

Further objects and advantages of the present invention will become apparent from the following descriptions, taken in connection with the accompanying drawings, wherein, by way of illustration and example, an embodiment of the present invention is disclosed.

The present invention is a method whereby computers equipped with standard Internet web browsers and standard multi-platform screen sharing programs will access a web server which then returns the necessary code to their browsers to connect them directly to a remote computer without an active connection to said web server for the actual screen sharing session.

According to the present invention a web server, in conjunction with a relational database program, automatically captures and stores the IP addresses, the type of web browser, the computer type and the kind of screen sharing software used by each of the guest computers.

Once the relational database program analyzes the captured information described on the previous paragraph, the relational database instructs the web server to present each guest with an ordinary htm1 (HyperText Markup Language, the authoring language used to create documents on the World Wide Web) page containing a link with active code using standard and common web 10 browser implementations such as Active X or a Java Applet. (ActiveX is not a programming language, but rather a set of rules for how applications should share information. An ActiveX control can be automatically downloaded and executed by a Web browser. Programmers can develop ActiveX controls in a variety of languages, including C, C++, Visual Basic, and Java. A Java Applet is a program designed to be executed from within another program. Unlike an application, applets cannot be executed directly from the operating system.)

If and when the users activate the link as described in the previous paragraph, the present invention will launch the screen sharing program from the web browser, allowing each guest computer to observe and/or control a remote computer directly without the need of having any of the involved computers connected to the web server.

The present invention does not require the host computer to be connected to the web server at any time as long as the host computer has a constant connection to the Internet and a static IP address. Otherwise the present invention will require the host computer to connect to the web server only once for the purpose of capturing its random IP address before a screen sharing session, but not during the actual screen sharing process.

The present invention may also be used as a management and/or access administration tool for the screen sharing process. To do this, the relational database is programmed with conditional expressions (Conditional expressions enable a program to act differently each time it is executed, depending on the input) which allow host computer operators to assign connection conditions, such as passwords, date and time restrictions, connection charges, etc., for each of the guest computers. Numerous conditions can be programmed to satisfy the operators of host computers and/or the operators of the computers with which they want to share their screens.

The present invention is a complete heterogeneous web browser screen sharing solution over the Internet. Any computer regardless of its kind or the web browsing and screen sharing software it uses is enabled to establish a screen-sharing link with any remote computer via the Internet. For example, a group of IBM compatible computers using the Windows Operating System, some of which use Internet Explorer and some of which use Netscape Navigator as their web browser, and another group of Macintosh computers, also with either type of web browser, can all be simultaneously involved in a screen sharing session to observe and/or control a remote host computer regardless of its kind (Macintosh or IBM compatible). The types of screen sharing software the computers use must be compatible.

The present invention allows screen sharing over the Internet without the development of web server applications for each specific platform. This is because relational database programs and the web servers used by this method are standard cross-platform technology already available and of standard use on heterogeneous Internet web servers.

The present invention provides a substantial reduction of bandwidth requirements to a web server in an Internet screen sharing system. The Internet web server is used only to transfer the set of instructions needed to activate the guest computers screen-sharing program and ceases to intervene during the actual screen sharing session.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1, 2 and 3 are system diagrams of homogeneous guest computers and their hardware and software requirements to take advantage of a web browser based screen-sharing system according to the present invention.

FIG. 4 and 5 are system diagrams of a homogeneous computer network where at least one of the computers acts as a web server to the remainder guest computers of said network in a web browser screen-sharing system according to the present invention.

FIG. 6 and 7 are diagrams of the web server instructions, which are stored in a relational database program according to the preferred embodiment of a web server in the present invention.

FIG. 8 and 9 are system diagrams of a heterogeneous screen sharing system with the emphasis on how the web server stores a remote computer's IP address and screen sharing program according to the present invention.

FIG. 10 and 11 are system diagrams of a heterogeneous screen sharing system with the emphasis on how the guest computers can observe and/or control the screen image of a remote or host computer in a web browser based screen sharing system according to the present invention.

### DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

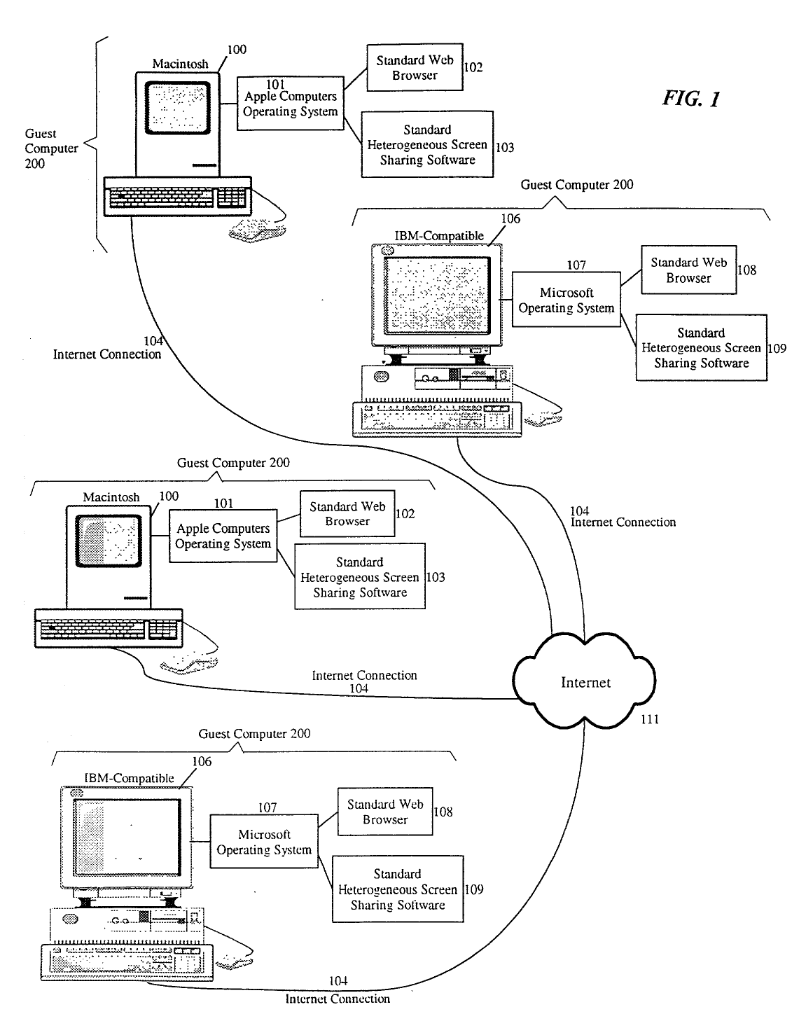

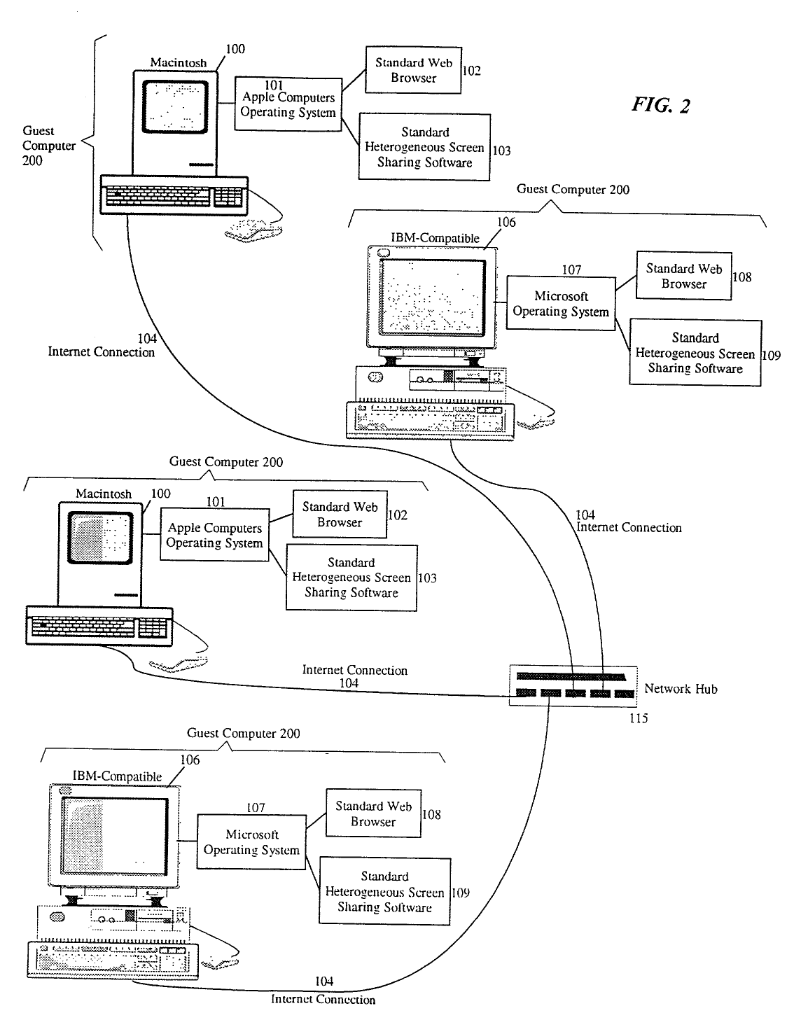

A method for screen image sharing among heterogeneous computers connected via a standard web browser without the involvement of a web server for the actual screen sharing session is provided to those computers constructed according to the preferred embodiment of the present invention. Thus, referring to FIGS. 1-2-3, the invention provides the method described on the previous paragraph to those computers equipped to run a standard web browser 102 and 108, a standard heterogeneous screen sharing software 103 and 109 and an Internet connection 104. Said computers having the characteristics described on the previous sentence will be referred from now on as “guest computers” 200. Further, the system according to the present invention may be used with two or more homogeneous computers, such as the Macintosh 100, and with two or more heterogeneous computers, such as the Macintosh 100 and the IBM-Compatible 106. Moreover, the system of the present invention may be used with both homogeneous and heterogeneous computers such as two Macintosh computers 100 and one or more IBM-Compatible computers 106. Further, the system of the present invention may be used with more than two different kinds of computers in a heterogeneous environment, as, for example, a Macintosh 100, an IBM-Compatible 104 and another Macintosh 100.

In addition, the homogeneous or heterogeneous computer platforms have to be coupled together by means of a TCP/IP connection such as an Internet network connection 112 and 113. It should be noted that the principles of the present invention are equally applicable to any combination of homogeneous and heterogeneous computers including, but not limited to, the Macintosh and the IBM-Compatible and equipped with a standard web browser, standard heterogeneous screen sharing software and TCP/IP network connection. It also should be noted that the principles of the present invention are equally applicable to any form of TCP/IP computer networking method, including, but not limited to, the Internet 104 and 110, wired or wireless LAN (Local Area Network, a computer network that spans a relatively small area.) / WAN (Wide area network, a computer network that spans a relatively large geographical area. Typically, a WAN consists of two or more local-area networks (LANs)) or any other type of TCP/IP data network connection 112 and 113 either with the use of a network hub 115 or without one.

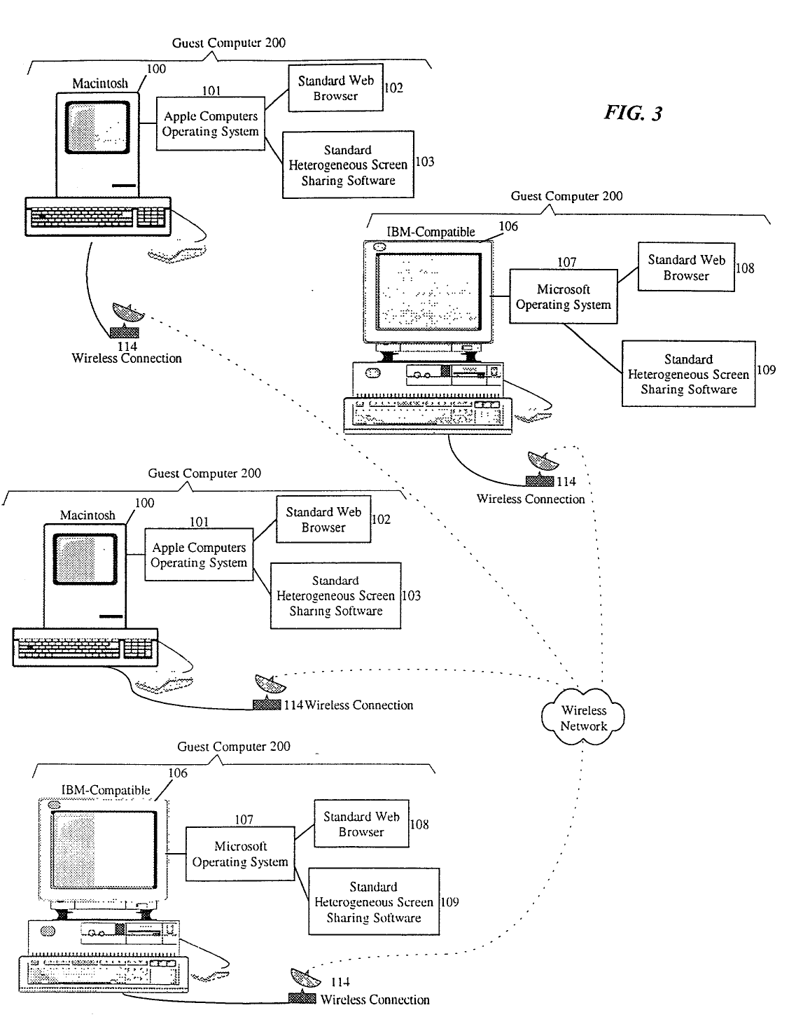

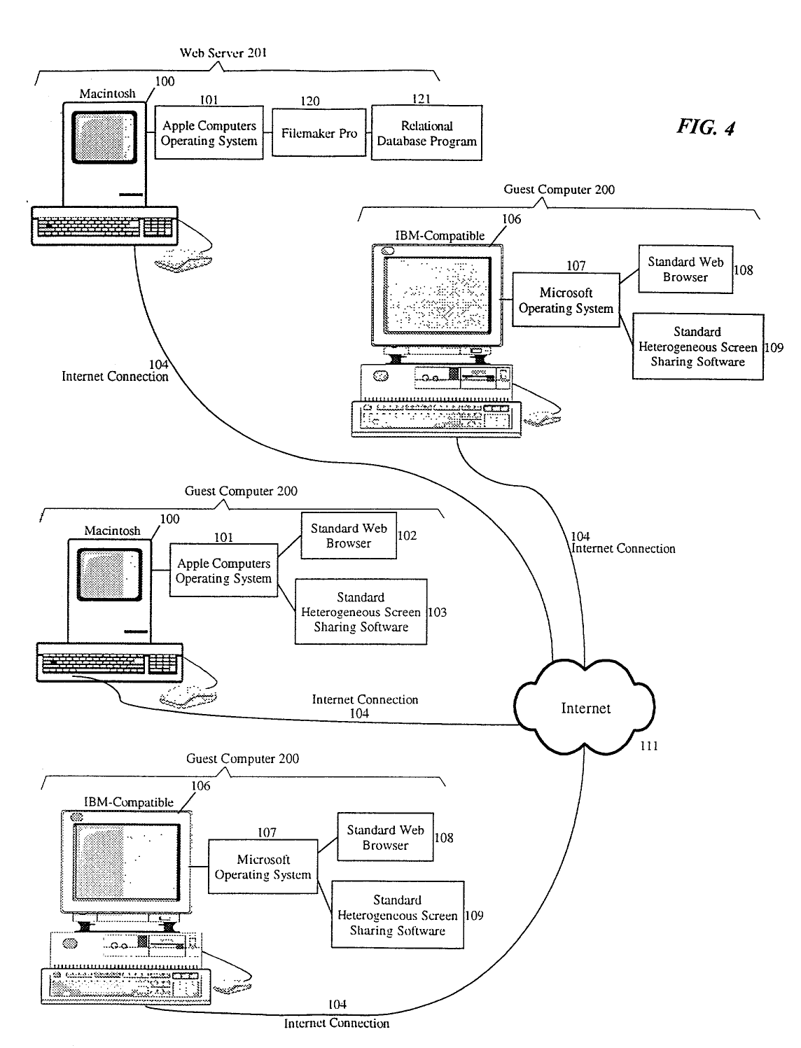

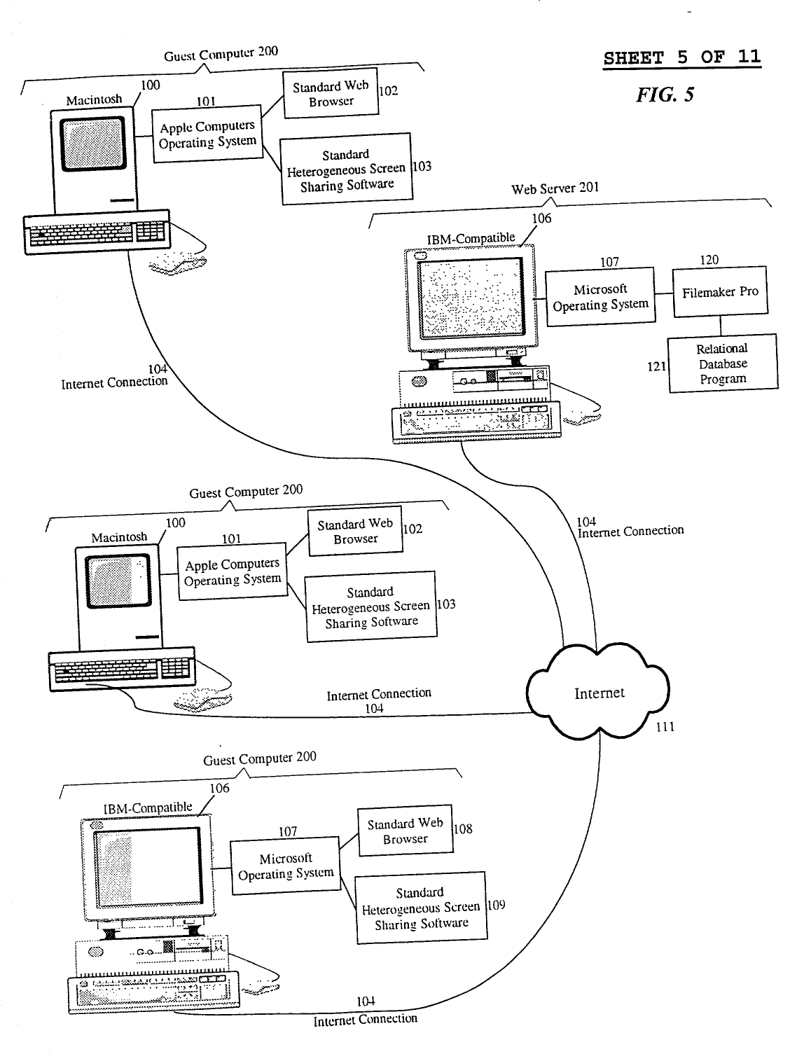

Referring now to FIG. 4-5, the invention makes use of standard relational database/web server software such as Filemaker Pro 120 (one of many standard cross-platform Relational Databases using TCP/IP), which can be equally installed on any of the Macintosh Computers 100 or any of the IBM-Compatible computers 106. Upon successful installation of Filemaker Pro 120 (or its equivalent), any of the Macintosh Computers 100 or any of the IBM-Compatible computers 106 automatically becomes a web server, including but not limited to those computers running Windows 95-98 or standard Macintosh Operating Systems. It should be noted that special operating systems normally required for internet web servers, such as Linux, Windows NT, Windows 2000 Server or Apple Share IP, are not needed. Upon execution of a Program 121 which contains the set of instructions on how the web server will respond to input, any of the Macintosh Computers 100 and any of the IBM-Compatible computers 106 will have the ability to act as an internet web server in a web based screen sharing system according to the preferred embodiment of the present invention. It should be noted that Program 121 works equally the same on any of the Macintosh Computers 100 and any of the IBM-Compatible Computers 106 without the need to re-create or develop its equivalent for each platform and/or operating system.

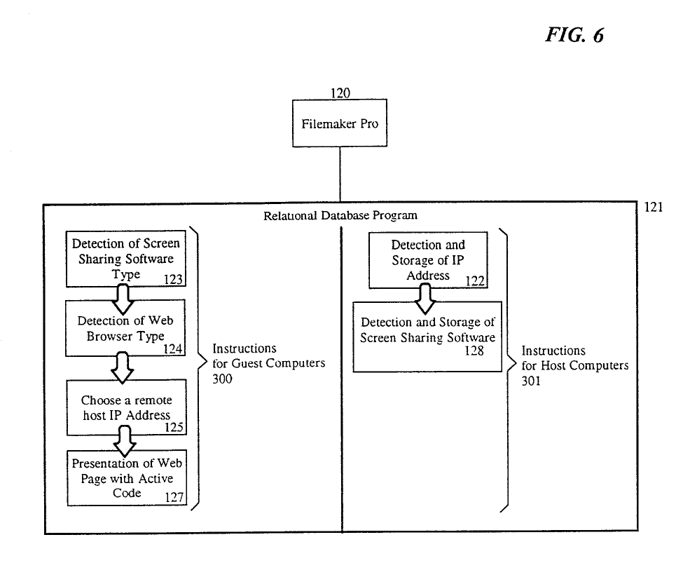

Referring now to FIG. 6, a set of instructions are stored in Program 121 which dictates how a computer responds to input when acting as a web server according to the preferred embodiment of the present invention. Program 121 has two separate groups of instructions. One group is a set of instructions with regards to input from guest computers 300 and the other group is a set of instructions to input from host computers 301. The minimum set of instructions required to respond to guest computers comprise 4 simple steps which are: the detection of its screen sharing software type 123; the detection of its web browser type 124; the choosing of the IP address 125 of an appropriate remote host computer; and, finally, the presentation of a standard web page with active code 127 using Java and/or Active X, whichever web browser implementation is suited best for the kind of computer and software of the guest computer. The minimum set of instructions with regards to remote computers comprises 2 simple steps, which are: the detection and/or storage of IP addresses 122; and, the detection and/or storage of screen-sharing software type 128.

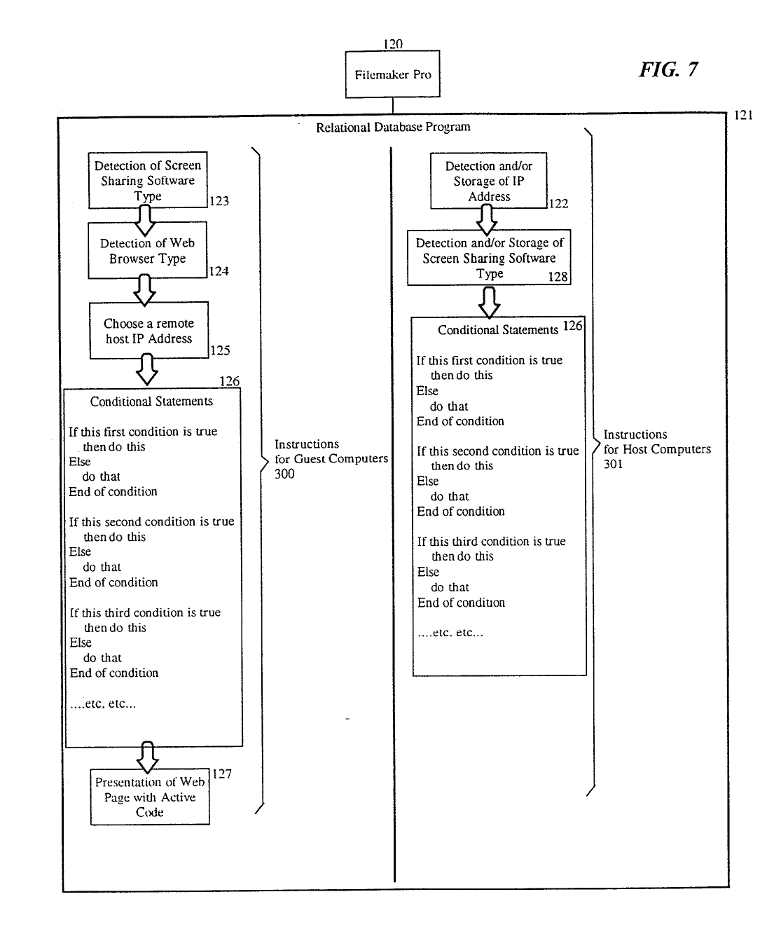

Referring now to FIG. 7, an infinite number of conditional statements 126 can be added to the instructions for guest computers 300 as well as for host computers 301 to put conditions, such as passwords, date and time restrictions, connection charges, etc., With regards to the instruction for guest computers 300, it should be noted that the conditional statements 126 could be placed for execution at any point before the presentation of the web page with active code. For example, 126 could be placed before the detection of screen sharing software type 123, immediately after Detection of Web Browser Type 124, or anywhere else in the sequence. With regards to the instructions for host computers 301, it should be noted that the conditional statements 126 could be placed for execution at any point. For example, 126 could be placed before the detection and/or storage of IP Address 122, or anywhere else in the sequence. Moreover, there is no specific sequence in which any of the comprising steps of the Instructions for Guest Computers 300 or the Instructions for Host Computers 301 have to be executed.

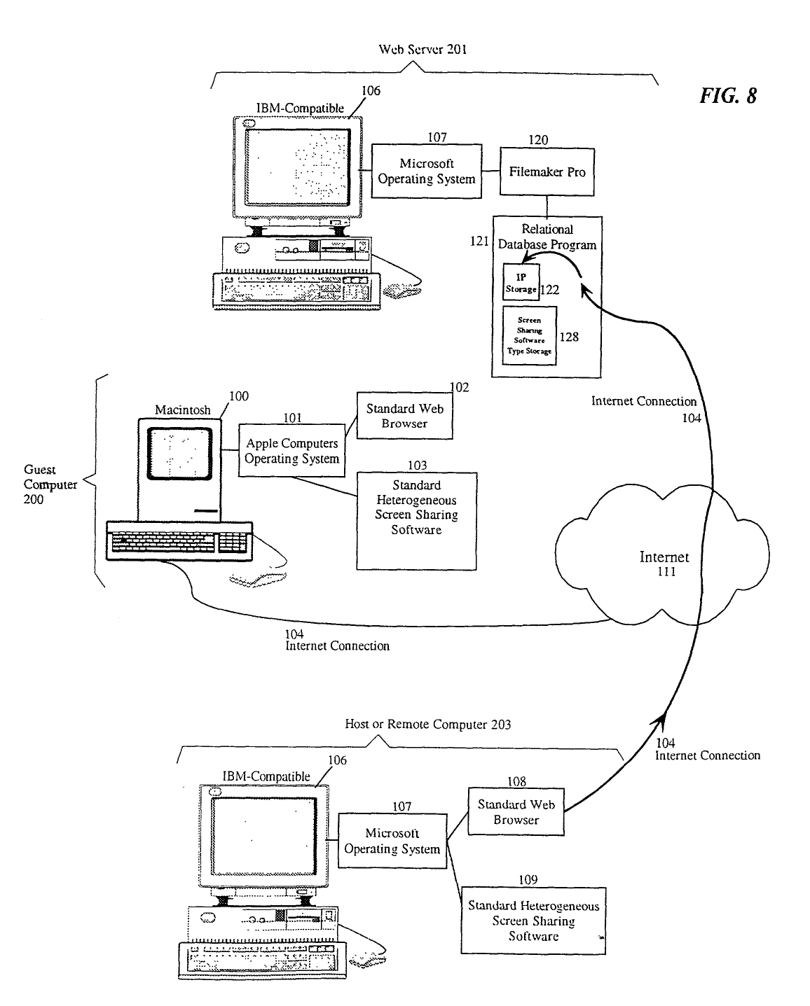

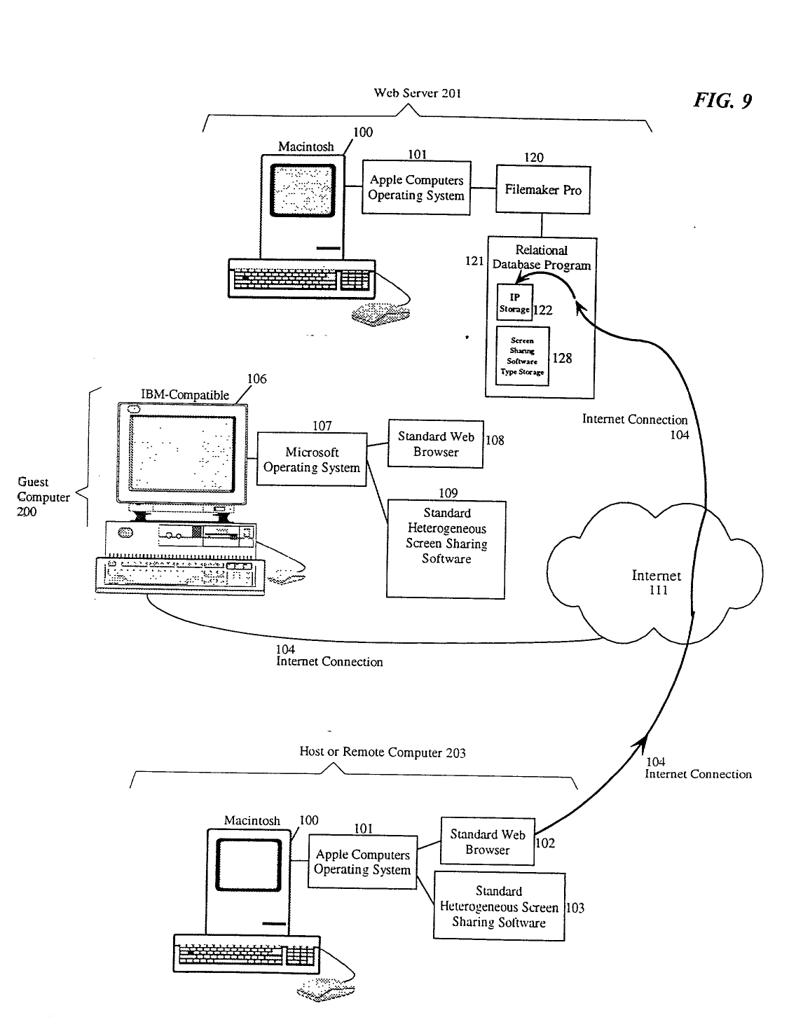

Referring now to FIG. 8-9, the present invention provides a method in which the IP address and screen-sharing software type of a remote host computer 203 is detected and/or stored in a relational database program 121. In the case where the host computer 203 has a constant internet connection and one static IP address, the user of said computer connects to the web server 201 only once via a standard web browser 108/102. The relational database program 121 automatically detects the IP address of the host or remote computer 203 and stores this information 122. The relational database program 121 also automatically detects and stores the type of screen sharing software 128 of the host or remote computer 203. In the case where the host computer 203 has a dial-up access to the Internet and is assigned a different IP address every time it connects to the Internet, the user of said computer connects to the web server 201 every time a screen sharing session is needed in order for the relational database program 121 to store the current IP address assigned to said host computer 203. It should be noted that any computer, which has been granted access to the relational database program 121, could also store the IP address of the host or remote computer 203 as long as said computer has the means to access web server 201. For example, a systems administrator could access the Web Server 201 and input the IP address of the remote computer 203 and the type of screen sharing software it uses.

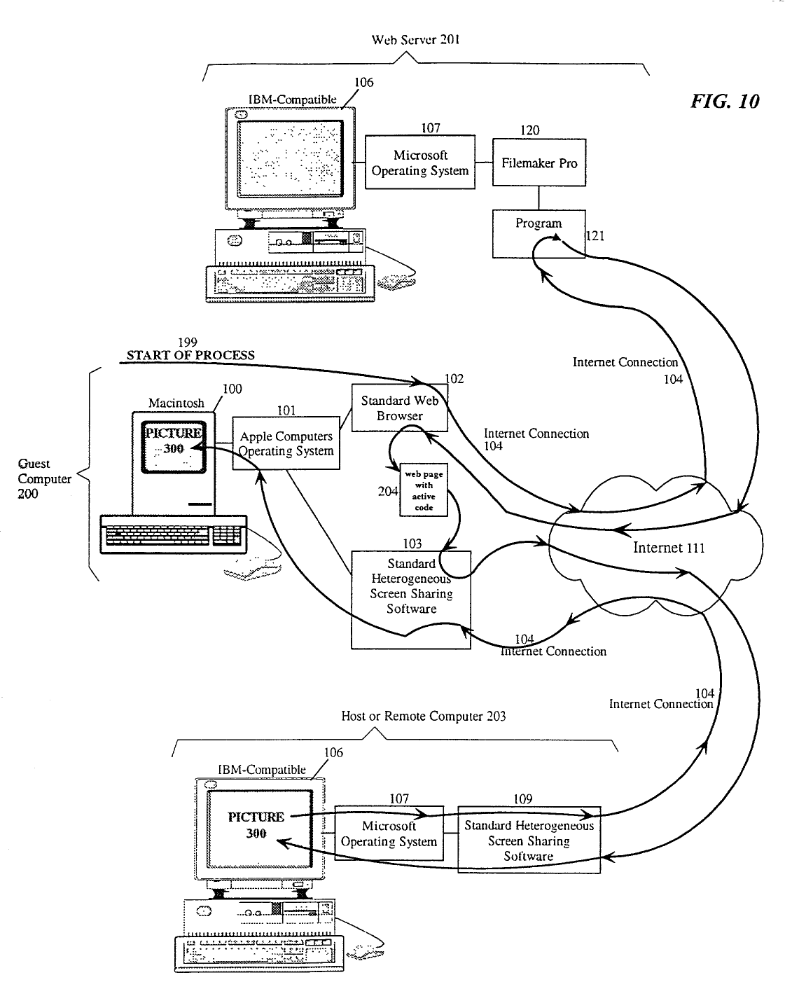

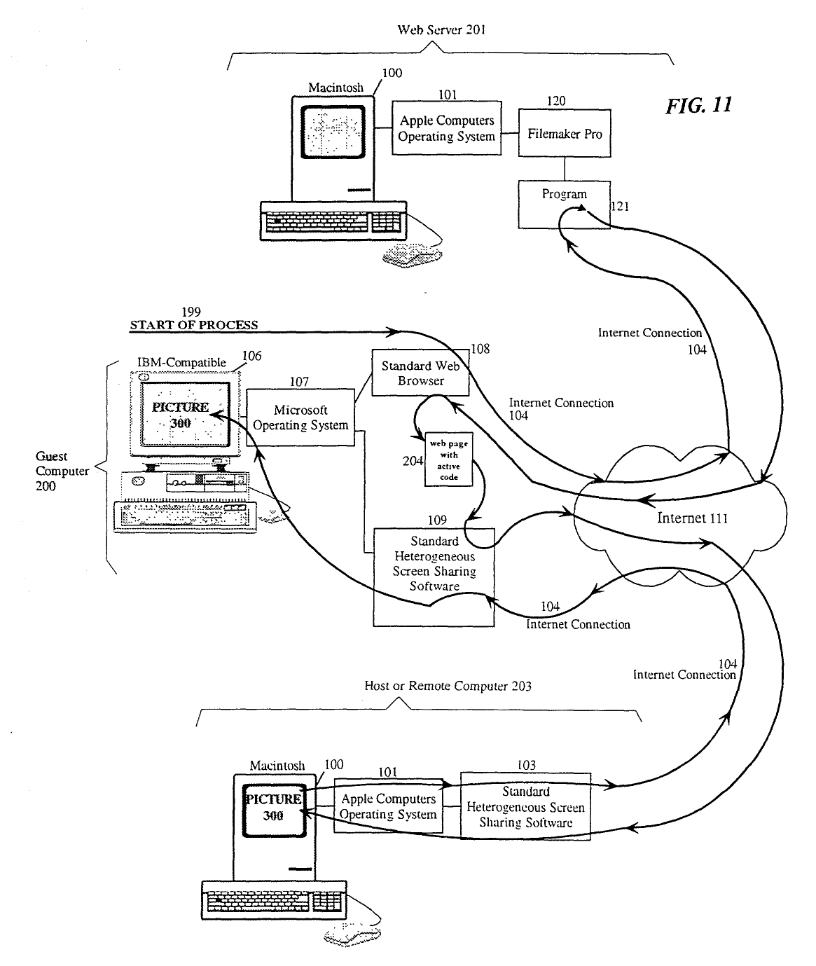

Referring now to FIG. 10 and 11, the present invention provides the method in which a user of a Guest Computer 200 such as the Macintosh 100 or the IBM-Compatible 106 accesses a Web Server 201 with a standard Web Browser 102/108 via an Internet connection 104. The Web Server 201 is driven by a relational database program 121 to display a web page with active code 204 on the browser 102/108 of the Guest Computer 200. The active code 204 contains a set of instructions for the Standard Heterogeneous screen sharing software 103/109 of the Guest Computer 200. Upon user activation of said web page with active code 204, the screen-sharing program 103/109 will use its Internet connection 104 to communicate with the screen-sharing program 103/109 of a host or remote computer 203 such as the IBM-Compatible 106 or the Macintosh 100. The screen-sharing program 103/109 of the remote computer 203 starts recording the screen image displayed on its monitor 300 and sends this information directly to the screen-sharing program 103/109 of the guest computer 200. The recorded screen image 300 is then played back on the Guest Computer 200.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A host computer for enabling peer-to-peer transfer of data over a computer network between a plurality of guest computers which are themselves operatively connectable over a computer network, the host computer comprising:
a host computing machine operatively connectable to a computer network;
a memory storage device operatively connected to said host computing machine; and
a computer program, stored in said memory storage device and executable by said host computing machine;
said computing machine executing said computer program to perform the steps of:
over a computer network, establishing connection to a plurality of guest computers;
for each of said plurality of guest computers, determining an IP address, a web browser type, a guest computer type, and a screen sharing software type;
to each of said plurality of guest computers, transferring a hypertext markup language page, said page containing a link with active code;
said active code containing data and containing instructions executable on each respective one of said plurality of guest computers, said data and instructions causing the operation of a screen sharing program on said respective one of said plurality of guest computers, said data and instructions further causing the transfer of data from one to another of said plurality of guest computers.

2. A host computer as set forth in claim 1, wherein said transfer of data from one to another of said plurality of guest computers is accomplished without subsequent connection of any of said plurality of guest computers to said host computer.

3. A method of viewing on a guest computer, over the Internet, a file which is stored on a remote computer, the method comprising the steps of:
providing a remote computer operatively connected to the Internet, said remote computer comprising a remote computer web browser program, a screen sharing program, and a memory containing in machine readable form a file which is viewable with the aid of said remote computer screen sharing program and transmissible over the Internet by said remote computer with the aid of said remote computer web browsing program;
providing a guest computer operatively connected to the Internet, said guest computer comprising a guest computer web browser program and a guest computer screen sharing program, said guest computer screen sharing program being capable of viewing said file stored in said memory of said remote computer, said guest computer web browsing program being capable of receiving over the Internet said file stored in said memory of said remote computer;
providing a web server operatively connected to the Internet, said web server comprising a web server web browser program;
operating said guest computer and said web server to construct on said web server a representation of guest computer parameters identified with said guest computer, said guest computer parameters including a guest computer screen sharing software type and a guest computer its web browser type;
operating said guest computer and said web server to identify to said web server the IP address of said remote computer;
operating said remote computer and said web server to construct on said web server a representation of remote computer parameters identified with said remote computer, said remote computer parameters including a remote computer IP address and a remote computer screen sharing software type;
operating said web server and said guest computer to transmit to said guest computer a web page with active code, said active code being executable on said guest computer, said active code being determined by said guest computer parameters and said remote computer parameters; and
executing said active code on said guest computer to operate said guest computer and said remote computer to transmit said file from said remote computer to said guest computer and to display said file on said guest computer.
